(19) United States
(12) Patent Application Publication
(10) Pub. No.: US 2004/0117492 A1
(43) Pub. Date: Jun. 17, 2004

(54) Electronic equipment and program

(75) Inventor: Tomoyuki Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/716,517

(22) Filed: Nov. 20, 2003

Related U.S. Application Data
(63) Continuation of application No. PCT/JP01/04612, filed on May 31, 2001.

(51) Int. Cl. G06F 15/16

(52) U.S. Cl. 709/229

(57) ABSTRACT

The present invention relates to electronic equipment connected to a communication line for accessing an access point via the communication line to perform an information communication. An object of the present invention is to provide electronic equipment capable of suitably setting up the access point without needs of expensive equipment. According to the electronic equipment of the present invention, there are prepared a schedule file, which records an action schedule, and an access point file which records an association between an access point and information as to a place, and the present seat is detected from the schedule file, so that the access point according to the seat is set up.

### TECHNICAL FIELD

The present invention relates to electronic equipment connected to a communication line for accessing an access point via the communication line to perform an information communication, and a program for setting up the access point on the electronic equipment when the program is executed in the electronic equipment.

### BACKGROUND ART

Recently, electronic equipment such as a notebook-sized personal computer has come into wide use. These days, as utilization of electronic equipment, such as a notebook-sized personal computer, in a mobile use, is increased, network connections utilizing modems are being done in every place.

However, in case of network connections through utilizing modems, for the purpose of saving the connection charge to telephone lines, there is a need to set up an access point according to the associated place.

In view of the foregoing, it is desirable to implement an environment capable of always setting up a suitable access point regardless of places and times.

Hitherto, in order to implement such an environment, it is known that position information detection function of GPS (Global Positioning System) and PHS (Personal Handyphone System) is utilized to detect the present position of the notebook-sized personal computer and the like, so that a suitable access point for the position is set up (cf. for example, Japanese Patent Laid Open Gazette TokuKai Hei. 11-146087).

However, an adoption of a system for detecting the position through utilizing of the GPS and the PHS involves a problem that for example, it is necessary to prepare excessive equipment when a network connection is performed through utilization of a cabled telephone line at the business trip destination.

In view of the foregoing, the objects of the present invention are to provide electronic equipment capable of suitably setting up the access point without needs of expensive equipment, and to provide a program of setting up a suitable access point on the electronic equipment when the program is executed in the electronic equipment.

### DISCLOSURE OF THE INVENTION

To achieve the above-mentioned object, the present invention provides electronic equipment connected to a communication line for accessing an access point via the communication line to perform an information communication, the electronic equipment comprising:

a schedule management section that manages a schedule including information as to date and time and places;

an access point management section that manages an association between information as to places and access points; and

a communication connecting section that obtains information as to a place at the present time from the schedule and obtains an access point according to the information as to a place at the present time from the association to connect with the access point.

According to the present invention, the present position is detected from the schedule to set up the access point. And thus, it is possible to set up a suitable access point without the necessity of the special equipment

In the electronic equipment according to the present invention as mentioned above, it is preferable that the access point management section manages the association between information as to places including index instead of a place name and access points, and

the communication connecting section has a mode in which upon receipt of an input according to an operation, of the information as to places including index, the access point according to the information as to places is detected from the association to connect with the access point.

Entrusting a set up destination of the access point to only the schedule brings about a possibility of setting errors of the access point when actions absent from the schedule or different from the schedule are taken.

In view of the foregoing, it is preferable to provide the manual mode in which upon receipt of input according to an operation, of the information as to the places, the access point according to the information as to the place entered is set up. In this case, it is preferable to set up a proper access point in such a manner that index of the place where one is now, or of the name of facilities near the place where one is now, for example, OO hotel, and ΔΔ station, is entered, but not entry of the proper place name (including address) of the place where one is now. As mentioned above, the management of the association between information as to the place including the index and the access point makes it possible to implement the manual mode easy in use.

In the electronic equipment according to the present invention as mentioned above, it is preferable that the schedule file management section and/or the access point management section manage the schedule and/or the association in such a manner that the schedule and/or the association are recorded on a recording medium separated from the electronic equipment, the recording medium being accessed in the electronic equipment.

As mentioned above, storage of the schedule or the association in a recording medium separated from the electronic equipment, for example, a smart card and a PC card, and keeping of the recording medium separated from the electronic equipment make it possible to prevent the improper communication in a burglary and the like, and thereby keeping a security.

To achieve the above-mentioned object, the present invention provides an access point set up program to be executed in electronic equipment connected to a communication line for accessing an access point via the communication line to perform an information communication, the electronic equipment comprising: a schedule management section that manages a schedule including information as to date and time and places; and an access point management section that manages an association between information as to places and access points, the access point set up program causing the electronic equipment to operate as:

a time obtaining section that obtains a present time;

a place obtaining section that obtains from the schedule information as to a place at the present time obtained in the time obtaining section;

an access point obtaining section that obtains from the association an access point according to the information as to a place obtained in the place obtaining section; and

an access point set up section that sets up the access point obtained in the access point obtaining section onto the electronic equipment.

In the access point set up program according to the present invention as mentioned above, it is preferable that the access point management section manages the association between information as to places including index instead of a geographical address and access points, and

the access point obtaining section has an automatic mode of obtaining from the association an access point according to the information as to a place obtained in the place obtaining section, and in addition a manual mode of obtaining the information as to a place entered in accordance with to an operation and of obtaining from the association an access point according to the entered information as to a place.

### BRIEF DESCRIPTION OF THE DRAWINGS

FIG. 1 is a perspective view of a notebook-sized personal computer, which operates in form of an embodiment of electronic equipment of the present invention.

FIG. 2 is an internal structural view of the notebook-sized personal computer shown in FIG. 1.

FIG. 3 is a functional block diagram of an access point set up function portion of the electronic equipment in form of an embodiment of the present invention.

FIG. 4 is a typical illustration of an embodiment of an access point set up program of the present invention and an embodiment of an access point set up program storage medium of the present invention.

FIG. 5 is a view showing an example of a schedule recorded on a schedule file.

FIG. 6 is a view showing an example of an access point table recorded on an access point file.

FIG. 7 is a view showing an icon list screen displayed on a liquid crystal display screen 121 of a notebook-sized personal computer 10 shown in FIG. 1.

FIG. 8 is a view showing an access point renewal screen.

FIG. 9 is a flowchart for an access point renewal program.

FIG. 10 is a view showing a schedule renewal screen.

FIG. 11 is a flowchart for a schedule renewal program.

FIG. 12 is a view showing a selection screen of automatic set up/manual set up of an access point.

FIG. 13 is a view showing an access point set up screen wherein an access point is manually set up.

FIG. 14 is a flowchart for an access point set up program of setting up an access point.

### BEST MODE FOR CARRYING OUT THE INVENTION

Hereinafter, there will be described embodiments of the present invention. Here, as an example of electronic equipment referred to in the present invention, a portable notebook-sized personal computer will be described.

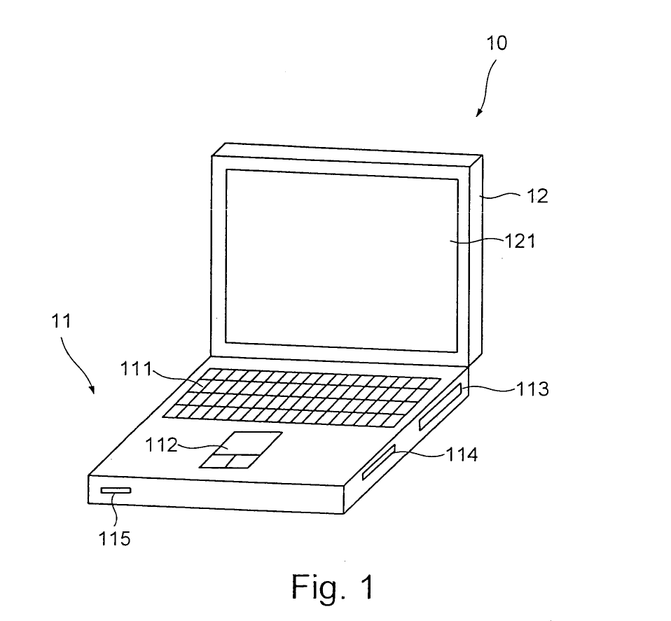

FIG. 1 is a perspective view of a notebook-sized personal computer, which operates in form of an embodiment of electronic equipment of the present invention.

The notebook-sized personal computer 10 comprises a main frame 11 and a display panel 12. The display panel 12 is mounted on the main frame 11 by hinges (not illustrated).

The main frame 11 incorporates therein a CPU, a magnetic disk and so on. On the top of the main frame 11, there are disposed a keyboard 111 and a track pad 112. On a side of the main frame 11, there are provided a CD-ROM mounting slot 113 onto which a CD-ROM is mounted and an FD mounting slot 114 onto which a flexible disk (FD) is mounted. Further, on the front of the main frame, there is provided a smart card mounting slot 115 onto which a smart card is mounted.

On the display panel 12, there is disposed a liquid crystal display screen 121 in front of the display panel 12 in a state that the display panel 12 is opened as shown in FIG. 1.

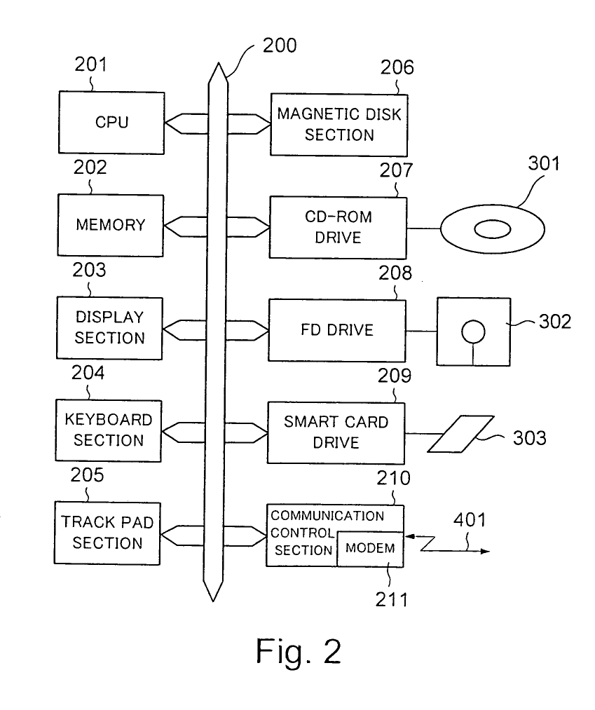

FIG. 2 is an internal structural view of the notebook-sized personal computer shown in FIG. 1.

The notebook-sized personal computer comprises a CPU 201, a memory 202, a display section 203, a keyboard section 204, a track pad section 205, a magnetic disk section 206, a CD-ROM drive 207, an FD drive 208, a smart card drive 209, and a communication control section 210. Those elements are connected to each other via a bus 200.

The magnetic disk section 206 comprises a magnetic disk and a magnetic disk drive for driving the magnetic disk. Various programs are installed in the magnetic disk. The magnetic disk section 206 has functions of reading the various programs from the magnetic disk and writing and saving new programs and data in the magnetic disk.

In the memory 202, a program read from the magnetic disk section 206 is developed, and the CPU 201 executes the program developed in the memory 202.

The main display section 203 is provided with the liquid crystal display screen 121 on the display panel 12 shown in FIG. 1 and has a function of displaying various sorts of images on the liquid crystal display screen 121.

The keyboard section 204 is provided with the keyboard 111 shown in FIG. 1 and has a function of transmitting a keyboard operation by a user of the notebook-sized personal computer to the CPU 201.

The track pad section 205 is provided with the track pad 112 shown in FIG. 1 and has a function of transmitting an operation of the track pad 112 by a user to the CPU 201.

The CD-ROM drive 207 accesses a CD-ROM 301 loaded through the CD-ROM mounting slot 113 shown in FIG. 1 to upload programs and data stored in the CD-ROM 301 into the notebook-sized personal computer 10.

The FD drive 208 accesses a flexible disk (FD) 302 loaded through the flexible disk mounting slot 114 shown in FIG. 1 so that data or the like stored in the FD 302 are received by the notebook-sized personal computer 10, or data or the like are written into the FD 302 from the notebook-sized personal computer 10. It is acceptable that programs stored in the FD 302 instead of the CD-ROM 301 are uploaded into the notebook-sized personal computer 10.

The smart card drive 209 accesses a smart card 303 loaded through the smart card mounting slot 115 shown in FIG. 1. The smart card 303 stores a schedule file and an access point file, which will be described later.

The communication section 212 has a modem 211, and is connected via a communication line 401 to an Internet.

It is acceptable that a program, to which the present invention is applied, is recorded onto a portable type of recording medium such as the above-mentioned CD-ROM and FD, and is read out from the recording medium so that the program is uploaded onto the notebook-sized personal computer 10. Alternatively, it is acceptable that the program is recorded on a magnetic disk in the notebook-sized personal computer 10 beforehand. Further, it is acceptable that the communication line 401 is utilized to obtain a program, to which the present invention saved in another apparatus is applied.

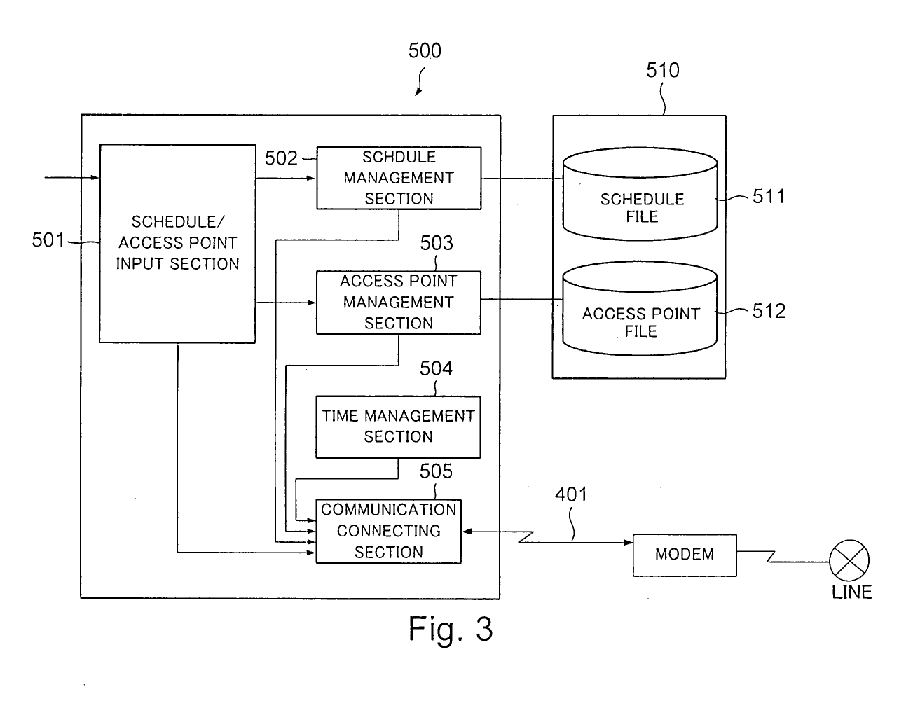

FIG. 3 is a functional block diagram of an access point set up function portion of the electronic equipment in form of an embodiment of the present invention.

The electronic equipment 500 shown in FIG. 3 comprises a schedule/access point input section 501, a schedule management section 502, an access point management section 503, a time management section 504, and a communication connecting section 505.

A recording medium 510 which is independent from the electronic equipment 500, comprises a schedule file 511, and an access point file 512.

The schedule/access point input section 501 corresponds to the keyboard and the mouse on a hardware basis. The schedule/access point input section 501 has a function of receiving input and alteration as to schedules and access points, and of transfer to the schedule management section 502 as to the schedules and of transfer to the access point management section 503 as to the access point.

The schedule management section 502 has a function of managing the schedule file 511 in such a manner that the schedule management section 502 checks data as to the schedules transferred from the schedule/access point input section 501 to write the data into the schedule file 511 or to read the schedule from the schedule file as the occasion demands.

The schedule file 511 records therein schedules including information as to times and places.

The access point management section 503 has a function of managing the access point file 512 in such a manner that the access point management section 503 checks data as to the access points transferred from the schedule/access point input section 501 to write the data into the schedule file 511 or to read the schedule from the schedule file as the occasion demands.

The access point file 512 records therein an association between information of places and access points.

The time management section 504 manages the present date and time.

The communication connecting section 505 has a function of obtaining the present date and time from the time management section 504, obtaining information as to places in the present date and time from among the schedule data recorded on the schedule file 511, from the schedule management section 502, and obtaining an access point according to information as to places in the present date and time from among the access point recorded on the access point file 512, from the access point management section 503, to connect that to the access point thus obtained.

The schedule/access point input section 501 has a manual mode wherein upon receipt of input of information as to the present position by operation of the operator of the electronic equipment 500, the schedule/access point input section 501 informs the communication connecting section 505 of that. At that time, the communication connecting section 505 receives from the access point management section 503 the access point according to the entered present position, which is recorded on the access point file 512, and connects that to the access point.

The access point file can record therein, as place information, not only proper place names, but also index capable of identifying a place, for example, hotel names, and names of facilities.

Accordingly, the electronic equipment 500 is connected to the access point associated with the index through inputting the index.

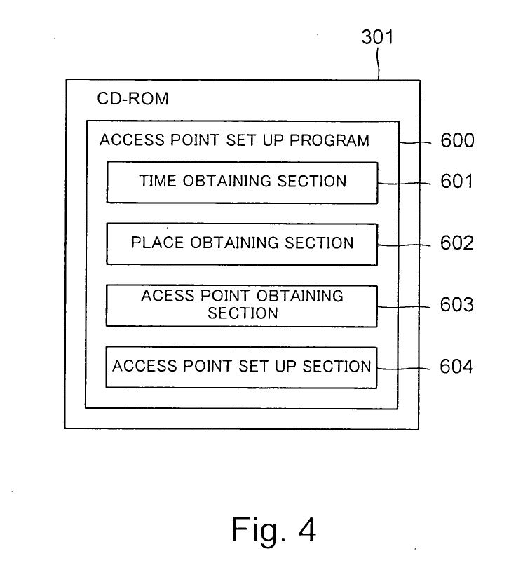

FIG. 4 is a typical illustration of an embodiment of an access point set up program of the present invention and an embodiment of an access point set up program storage medium of the present invention.

The access point set up program 600 is stored in the CD-ROM 301. The CD-ROM 301 is mounted onto the notebook-sized personal computer 10 through the CD-ROM mounting slot 113 (cf. FIG. 1) and is accessed by the CD-ROM drive 207 (cf. FIG. 2), so that the access point set up program 600 stored in the CD-ROM 301 is installed in the notebook-sized personal computer 10. Execution of the access point set up program 600 installed in the notebook-sized personal computer may constitute the communication connecting section 505 of the electronic equipment 500 shown in FIG. 3.

The access point set up program 600 comprises program components of a time obtaining section 601, a place obtaining section 602, an access point obtaining section 603, and an access point set up section 604.

Incidentally, the access point set up program 600 shown in FIG. 4 is an application program constituting the communication connecting section 505 of the electronic equipment 500 shown in FIG. 3, and does not include programs associated with other constituting elements of the electronic equipment 500 shown in FIG. 3, that is, the schedule/access point input section 501, the schedule management section 502, the access point management section 503, the time management section 504, and the communication connecting section 505. The reason why this is to do so is as follows: With respect to the management of the schedule, it is possible to adopt ones, which come onto the market as the schedule management software; with respect to the management of the access point, it is possible to adopt ones, which come onto the market as the table management software; with respect to the management of the time, it is possible to adopt the time management function provided on the notebook-sized personal computer shown in FIG. 1, and it is effective that the access point set up program 600 works in cooperation with those types of software and the time management function, and thus there is no need that the access point set up program includes those elements. However, it is acceptable that the access point set up program 600 includes software for an access point management and software for a schedule management as well as the program components 601 to 604 shown in FIG. 4.

The time obtaining section 601, which constitutes the access point set up program 600 shown in FIG. 4, has a function of obtaining the present time from the time management section 504 of the electronic equipment 500 shown in FIG. 3.

The place obtaining section 602 obtains information as to a place at the present time, which is obtained in the time obtaining section 601, from among the schedule data recorded on the schedule file 511, upon requesting of the schedule management section 502.

The access point obtaining section 603 obtains an access point according to information as to a place, which is obtained in the place obtaining section 602, from the access point file 512, upon requesting of the access point management section 503.

The access point obtaining section 603 has a manual mode in which upon obtaining information as to a place entered in accordance with an operation an access point according to the entered information as to the place is obtained from the access point file as well as an automatic mode in which an access point according to the entered information as to the place obtained in the place obtaining section 602 is obtained from the access point file 512.

The access point set up section 604 sets up the access point obtained in the access point obtaining section 603 on the communication control section 210 shown in FIG. 2, which constitutes the communication connecting section 505 (FIG. 3) of the electronic equipment 500 (here, the notebook-sized personal computer 10 shown in FIG. 1 and FIG. 2) wherein the access point set up program 600 is operating. Then, the communication control section 210 uses the modem 211 to connect that to the access point thus set up.

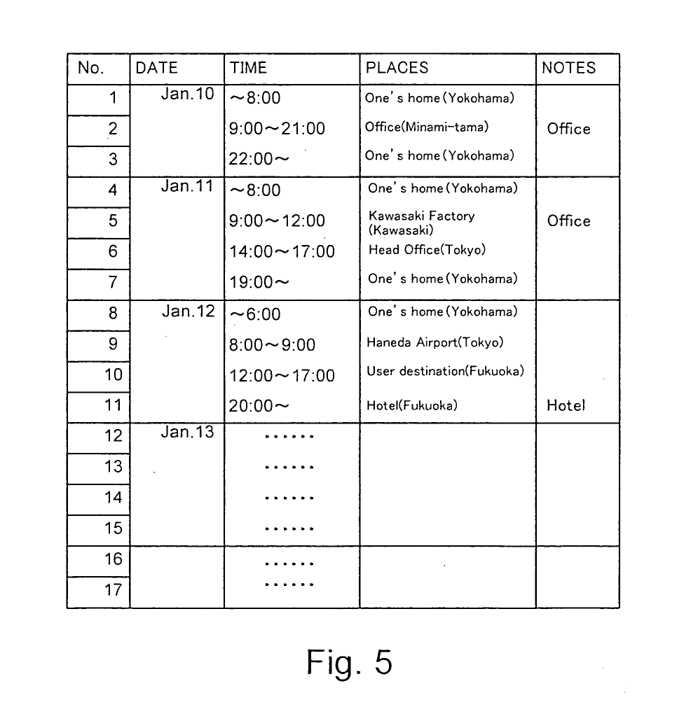

FIG. 5 is a view showing an example of a schedule recorded on a schedule file.

As shown in this example, this schedule includes date, time and places, and it is possible to enter comments and memorandums in the notes.

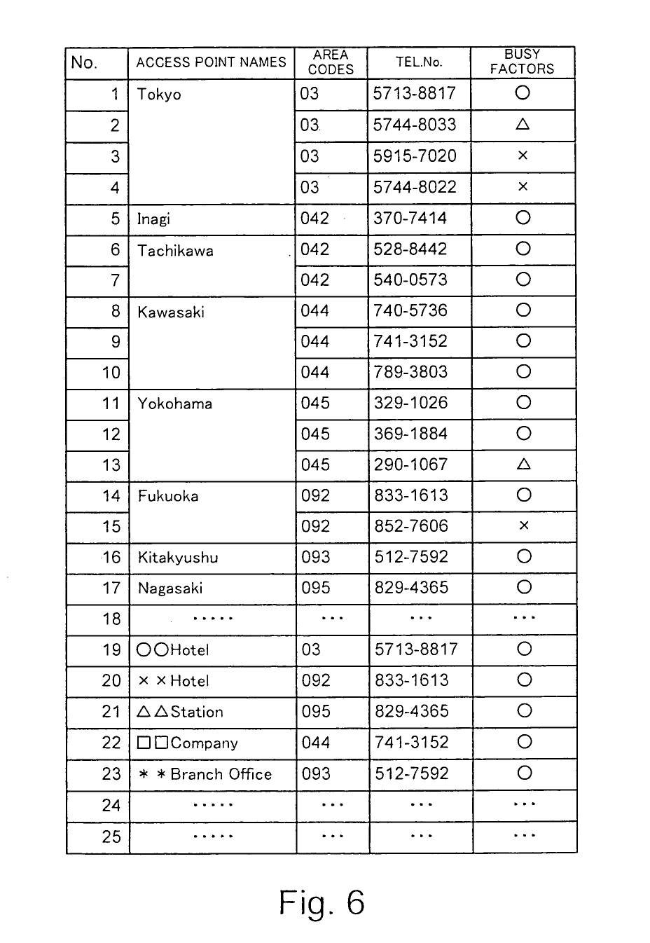

FIG. 6 is a view showing an example of an access point table recorded on an access point file. On this access point table, there are recorded place information (access point names) and access points (area codes and telephone numbers. And further, busy factors each representative of an average busy degree of the access point are indicated by marks of O, Δ and x in the order of average vacancy.

In the column of the place information (access point names), it is possible to record not only place names such as Tokyo and Yokohama, but also indexes such as OO hotel, ΔΔ station, and companies. At that time, any one is acceptable, as the index, which is information of a place for an operator of the electronic equipment (a notebook-sized personal computer), and there is no need that one, which is objectively specified in place, is concerned.

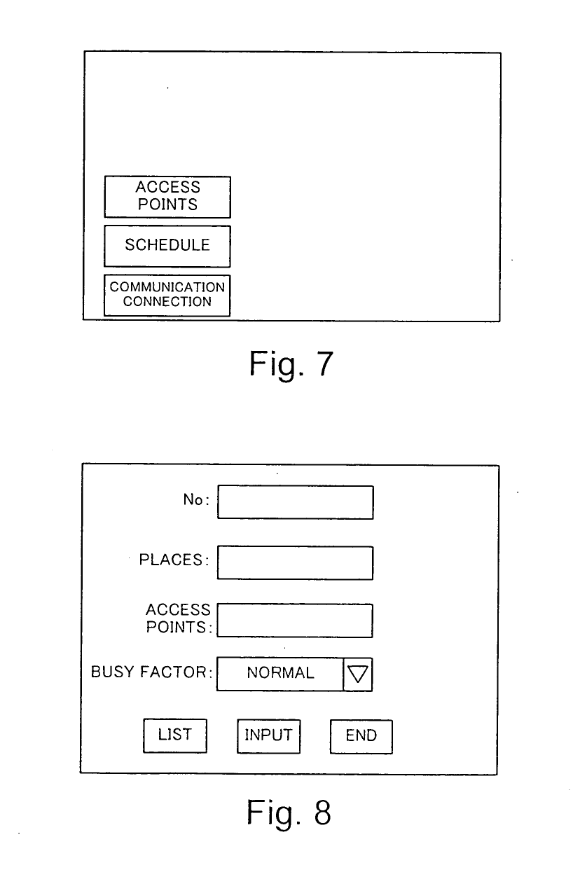

FIG. 7 is a view showing an icon list screen displayed on a liquid crystal display screen 121 of a notebook-sized personal computer 10 shown in FIG. 1.

Here, there are shown only icons, which are necessary for the explanation of the features of the present embodiment.

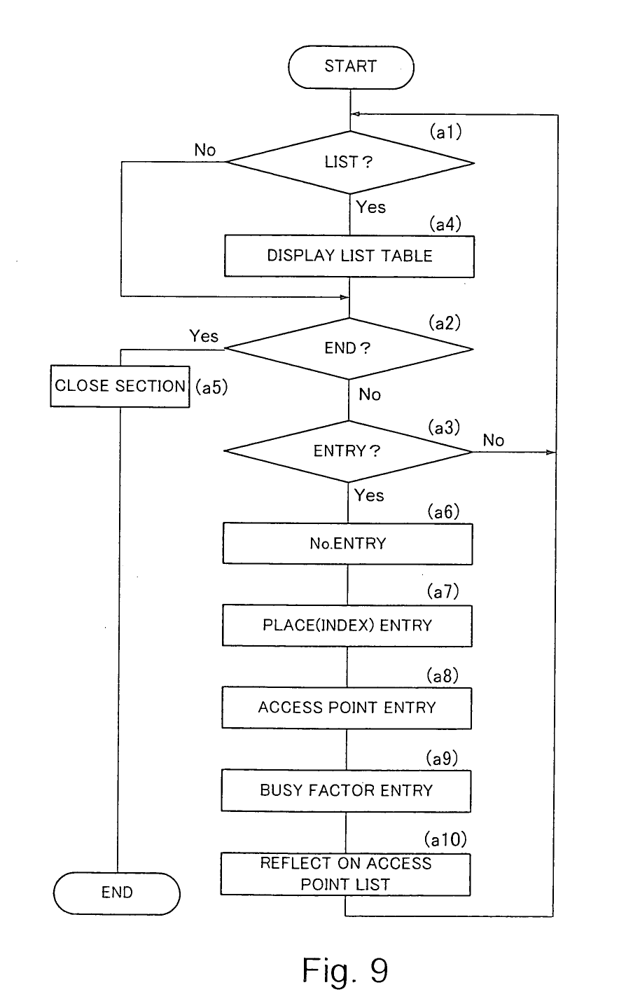

FIG. 8 is a view showing an access point renewal screen. FIG. 9 is a flowchart for an access point renewal program. This access point renewal program does not constitute the access point set up program 600 shown in FIG. 4, but the access point renewal program is necessary for the entry of the access point in the schedule/access point input section 501 and the operation of the access point management section 503, of the electronic equipment 500 shown in FIG. 3.

When the icon of the “access point” is clicked on the icon list screen shown in FIG. 7 through the operation of the track pad shown in FIG. 1, the access point renewal screen shown in FIG. 8 is displayed on the liquid crystal display screen 121, and CPU 201 of the notebook-sized personal computer 10 executes the access point renewal program shown in FIG. 9.

On the access point renewal screen shown in FIG. 8, there are entered numbers (No.), places (index), telephone numbers of the access points (including an area code), and busy factors. Here, the busy factor is selected from among the “normal” (corresponding to the mark Δ in FIG. 6), the “busy” (corresponding to the mark x in FIG. 6), and the “free” (corresponding to the mark O in FIG. 6).

The numbers (No.) are inputted when the access point, which has been already registered, is altered or deleted.

When the “list” is clicked, the access point list as shown in FIG. 6 is displayed on the liquid crystal display screen.

When the “input” is clicked, the contents described on the screen of FIG. 8 are reflected on the access point list.

When the “end” is clicked, the access point renewal screen is closed.

In the access point renewal program of FIG. 9, it is monitored that any one of the “list”, the “end” and the “input” of FIG. 8 is clicked (steps al to a3). When the “list” is clicked, the access point list as shown in FIG. 6 is displayed on the liquid crystal display screen 121 (cf. FIG. 1) in addition to the screen shown in FIG. 8. Accordingly, it is possible for an operator to perform renewal and addition of the access point while confirming the access point list.

When the “end” is clicked (step a2), the screen of FIG. 8 and the access point list screen are closed (step a5).

When the “input” of is clicked, No., places (index), access points and busy factors, which are entered on the screen of FIG. 8 prior to the click of the “input”, are entered into the program (step a6 to step a9), and are reflected on the access point list (step a10). Those items are reflected on the access point list in such a manner that, in the event that a number (No.) of the access point, which has been already registered, is entered, and the place and the access point are entered, the access point of the number (No.) is overwritten; in the event that only the number (No.) of the access point is entered, and the place and the access point are not entered, the access point of the number (No.) is erased; and in the event that the number (No.) of the access point is not entered, or number of a blank is entered, and the place and the access point are entered, the access point is added to the access point list.

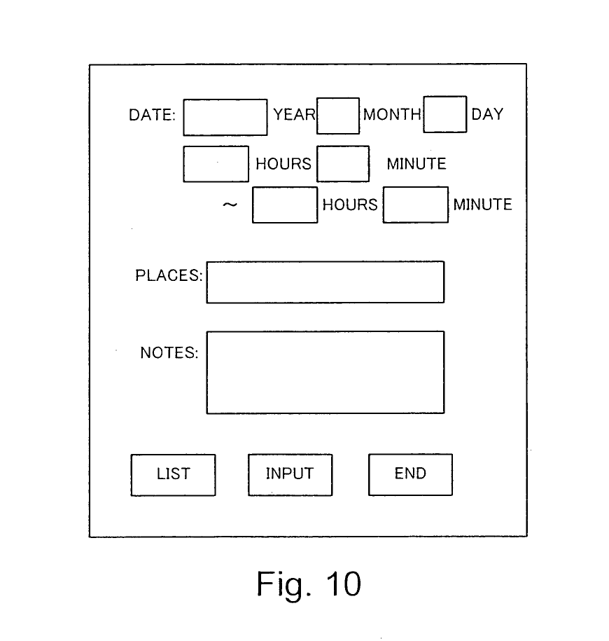

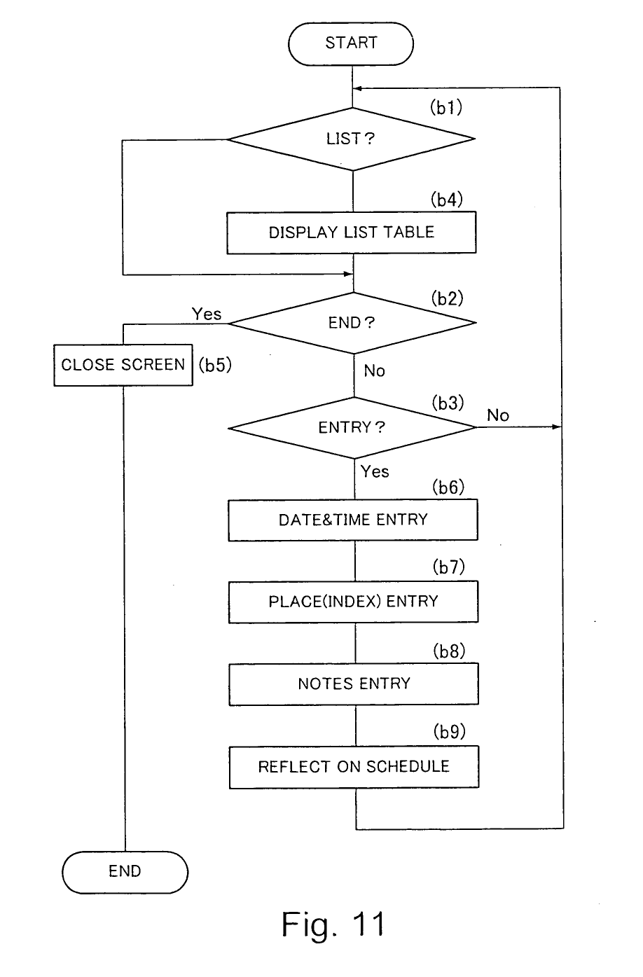

FIG. 10 is a view showing a schedule renewal screen. FIG. 11 is a flowchart for a schedule renewal program. This schedule renewal program also does not constitute, in a similar fashion to that of access point renewal program shown in FIG. 9, the access point set up program 600 shown in FIG. 4, but the schedule renewal program is necessary for the entry of the schedule in the schedule/access point input section 501 and the operation of the schedule management section 502, of the electronic equipment 500 shown in FIG. 3.

When the icon of the “schedule” is clicked on the icon list screen shown in FIG. 7 through the operation of the track pad shown in FIG. 1, the schedule renewal screen shown in FIG. 10 is displayed on the liquid crystal display screen 121, and the CPU 201 of the notebook-sized personal computer 10 executes the schedule renewal program shown in FIG. 11.

On the schedule renewal screen shown in FIG. 10, there are entered date and time (year, month and date, hour, minute), and places (index). And comments and memorandums are entered in the column of the notes as the occasion demands.

When the “list” is clicked, the schedule list as shown in FIG. 5 is displayed on the liquid crystal display screen.

When the “input” is clicked, the contents entered on the screen of FIG. 10 are reflected on the schedule list.

When the “end” is clicked, the schedule renewal screen is closed, and when the schedule list is displayed, its screen is closed.

In the schedule renewal program of FIG. 11, it is monitored that any one of the “list”, the “end” and the “input” of FIG. 11 is clicked (steps b1 to b3). When the “list” is clicked, the schedule list as shown in FIG. 5 is displayed on the liquid crystal display screen 121 (cf. FIG. 1) in addition to the screen shown in FIG. 8. Accordingly, it is possible for an operator to perform renewal and addition of the schedule while confirming the schedule list.

When the “end” is clicked (step b2), the screen of FIG. 10 and the schedule list screen are closed (step b5).

When the “input” of is clicked, date and time, places (index), and notes, which are entered on the screen of FIG. 10 prior to the click of the “input”, are entered into the program (step b6 to step b9), and are reflected on the schedule list (step b9). Those items are reflected on the schedule list in such a manner that, in the event that date and time, which are overlapped with date and time already registered, are entered, and the place and the like are entered, the schedule of the date and time is altered; in the event that only the overlapped date and time is entered, and the place and the like are not entered, the schedule of the date and time is erased; and in the event that date and time not entered in the schedule list is entered, and the place and the like are entered, the schedule of the date and time is added to the schedule list.

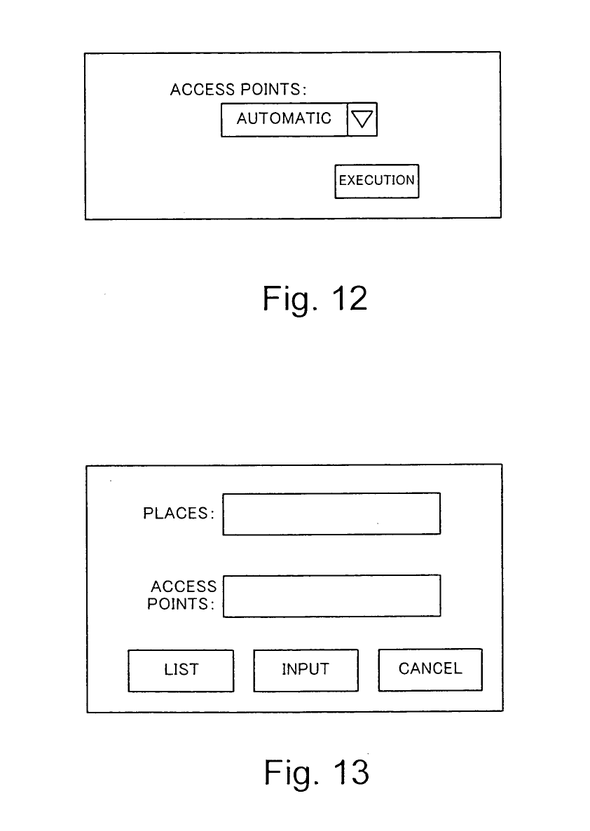

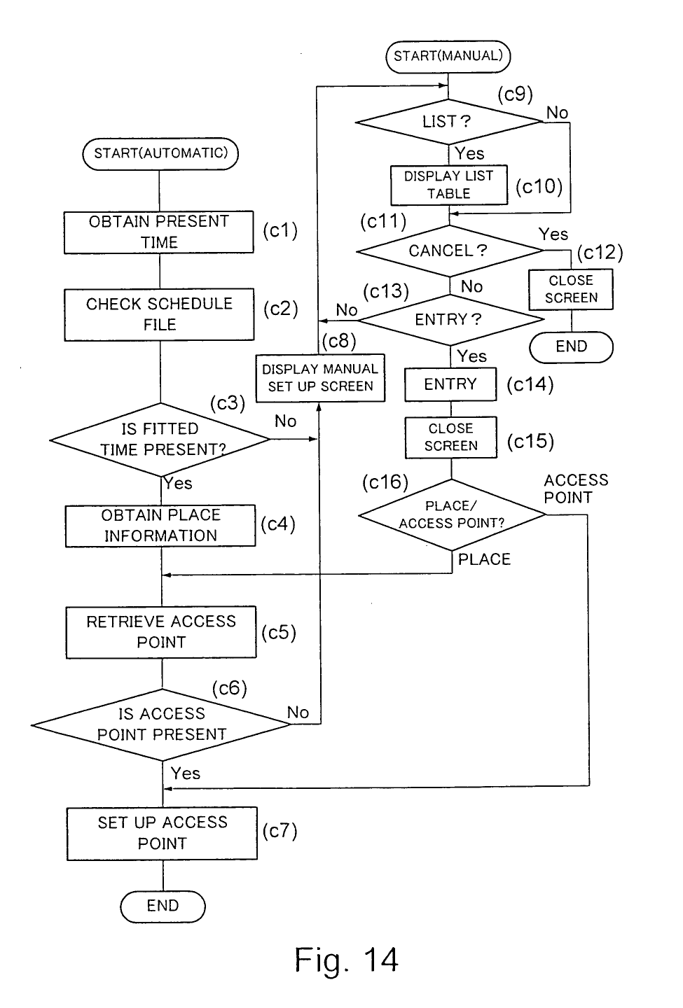

FIG. 12 is a view showing a selection screen of automatic set up/manual set up of an access point. FIG. 13 is a view showing an access point set up screen wherein an access point is manually set up. FIG. 14 is a flowchart for an access point set up program of setting up an access point.

After a jack for a telephone line of the electronic equipment (notebook-sized personal computer) is inserted into a terminal of the notebook-sized personal computer at the place where one has gone, or at the company or one's home, when the icon of the “communication connection” is clicked on the icon list screen shown in FIG. 7, there is displayed the selection screen of automatic set up/manual set up of an access point, as shown in FIG. 12. When “automatic” is selected and a button “execution” is clicked on this screen, an automatic set up of an access point is implemented. On the other hand, when “manual” instead of “automatic” is selected and the button “execution” is clicked, an access point manual set up screen as shown in FIG. 13 is displayed.

Either one of the places (index) or the access points is entered onto the access point manual set up screen as shown in FIG. 13. In FIG. 13, a “list” denotes a button for displaying the access point list as shown in FIG. 6. An “input” denotes a button for taking in the access point set up program of FIG. 14 the place or the access point entered onto the access point manual set up screen of FIG. 3. A “cancel” denotes a button for canceling the manual set up.

When “automatic” is set up on the selection screen of automatic set up/manual set up shown in FIG. 12, first, information as to the present date and time is obtained from the time management section 504 (step c1 in FIG. 14). Accordingly, the step c1 corresponds to the time obtaining section 601 of the access point set up program 600 shown in FIG. 4.

Next, the access point set up program shown in FIG. 14, a schedule file is checked (step c2), and it is determined whether the schedule file includes a schedule of date and time fitted for the date and time obtained in the step c1 (step c3).

When the schedule file does not include the schedule of date and time fitted for the date and time obtained in the step c1, the program goes to step c8 in which the access point manual set up screen as shown in FIG. 13 is displayed, and the mode is changed to a manual set up mode.

In the step c3, when it is decided that the schedule file includes the schedule of date and time fitted for the date and time obtained in the step c1, the program goes to step c4 in which information as to places is obtained from the schedule of the date and time. Accordingly, the steps c2 to c4 correspond to the place obtaining section 602 of the access point set up program 600 shown in FIG. 4.

In the access point set up program shown in FIG. 14, the access point file is referred to so as to retrieve an access point associated with the same place as the obtained place information (step c5). When the access point of the same place as the place information obtained in the step c4 is recorded in the access point file, such a access point is set up, as an access point to be connected, to the communication control section 210 of FIG. 1 constituting the communication connecting section 505 of FIG. 3 (step c7). The communication control section 210 connects with the access point using the modem 211.

In step c6, when there is not found an access point of the same place as the place information obtained in the step c4, the program goes to the step c8 in which the access point manual set up screen as shown in FIG. 13 is displayed, in a similar fashion to a case where in the step c3 there is not found the fitted date and time.

When the manual set up is set on the selection screen of automatic set up/manual set up of an access point as shown in FIG. 12, or when it is decided in the step c3 of FIG. 14 that no fitted data and time is present, or when it is decided in the step c6 that no fitted access point is present, the manual set up screen shown in FIG. 13 is displayed so that “place” or “access point” is entered on the manual set up screen.

When the “list” is clicked on the manual set up screen shown in FIG. 13 (step c9), the access point list as shown in FIG. 6 is displayed. It is acceptable that “manual” is set up on the screen of FIG. 12 and the access point list is displayed, so that the place or the access point is entered on the screen of FIG. 13 while referring to the displayed access point list.

In step c11, it is determined whether “cancel” was clicked. When it is decided that “cancel” was clicked, the screen of FIG. 13 and the access point list screen if it is opened are closed (step c12), and this routine is terminated.

When “input” is clicked on the screen of FIG. 13 (step c13), the entry column of “place” of FIG. 13 and the entry column of “access point” are inputted into the program (step c14), the screen of FIG. 13 and the access point list screen if it is opened are closed (step c15), and then it is decided whether the entered data is concerned with information of the place or the access point (step c16). When the entry was done in both the entry columns of “place” and “access point” of FIG. 13, the access point takes priority.

When the place is entered, the program goes to the step c15 in which as mentioned above, the retrieval of the access point associated with the entered place information is carried out. On the other hand, when the access point is entered on the screen of FIG. 13, the program goes to step c7 in which the entered access point is set up.

Thus, according to the present embodiment, recording of schedules in electronic equipment (notebook-sized personal computer) makes it possible to implement an automatic set up of access points and a manual set up of access points as well.

As mentioned above, according to the present invention, it is possible to connect with a suitable access point without needs of expensive equipment such as GPS and PHS.

What is claimed is:

1. Electronic equipment connected to a communication line for accessing an access point via the communication line to perform an information communication, the electronic equipment comprising:
a schedule management section that manages a schedule including information as to date and time and places;
an access point management section that manages an association between information as to places and access points; and
a communication connecting section that obtains information as to a place at the present time from the schedule and obtains an access point according to the information as to a place at the present time from the association to connect with the access point.

2. Electronic equipment according to claim 1, wherein the access point management section manages the association between information as to places including index instead of a place name and access points, and
the communication connecting section has a mode in which upon receipt of an input according to an operation, of the information as to places including index, the access point according to the information as to places is detected from the association to connect with the access point.

3. Electronic equipment according to claim 1, wherein the schedule file management section and/or the access point management section manage the schedule and/or the association in such a manner that the schedule and/or the association are recorded on a recording medium separated from the electronic equipment, the recording medium being accessed in the electronic equipment.

4. An access point set up program to be executed in electronic equipment connected to a communication line for accessing an access point via the communication line to perform an information communication, the electronic equipment comprising: a schedule management section that manages a schedule including information as to date and time and places; and an access point management section that manages an association between information as to places and access points, the access point set up program causing the electronic equipment to operate as:
a time obtaining section that obtains a present time;
a place obtaining section that obtains from the schedule information as to a place at the present time obtained in the time obtaining section;
an access point obtaining section that obtains from the association an access point according to the information as to a place obtained in the place obtaining section; and
an access point set up section that sets up the access point obtained in the access point obtaining section onto the electronic equipment.

5. An access point set up program according to claim 4, wherein the access point management section manages the association between information as to places including index instead of a geographical address and access points, and
the access point obtaining section has an automatic mode of obtaining from the association an access point according to the information as to a place obtained in the place obtaining section, and in addition a manual mode of obtaining the information as to a place entered in accordance with to an operation and of obtaining from the association an access point according to the entered information as to a place.
